(19) United States
(12) Patent Application Publication
(10) Pub. No.: US 2024/0218230 A1
(43) Pub. Date: Jul. 4, 2024

(54) Thixotropically Molded Product And Thixotropic Molding Material

(71) Applicant: SEIKO EPSON CORPORATION, Tokyo (JP)

(72) Inventors: Yasutoshi HIDESHIMA, Matsumoto (JP); Setsuya IWASHITA, Nirasaki (JP); Fumiya MAEDA, Matsumoto (JP); Shunsuke UCHIZONO, Shiojiri (JP); Koichi OZAKI, Okayama (JP); Tadao FUKUTA, Kurashiki (JP)

(21) Appl. No.: 18/397,694

(22) Filed: Dec. 27, 2023

(30) Foreign Application Priority Data
Dec. 28, 2022 (JP) 2022-211887

(51) Int. Cl. C09K 5/14; C22C 22/00

(52) U.S. Cl. CPC C09K 5/14; C22C 22/00

(57) ABSTRACT

A thixotropically molded product includes: a matrix portion containing Mg as a main component; and carbon fibers dispersed in the matrix portion. An area fraction of the carbon fibers in a cross section is 1.0% or more and 30.0% or less. An average fiber length of the carbon fibers may be 15 μm or more and 150 μm or less.

The present application is based on, and claims priority from JP Application Serial Number 2022-211887, filed Dec. 28, 2022, the disclosure of which is hereby incorporated by reference herein in its entirety.

### BACKGROUND

### 1. Technical Field

The present disclosure relates to a thixotropically molded product and a thixotropic molding material.

### 2. Related Art

Magnesium has properties of a low specific gravity and good electromagnetic wave shielding properties, good vibration damping capability, good machinability, and good biosafety. Based on such a background, magnesium alloy components are beginning to be used in products such as automobile components, aircraft components, mobile phones, and notebook computers.

A thixotropic molding method is known as a method of producing components made of magnesium. The thixotropic molding method is a molding method in which a molding material is heated in a cylinder to bring the material into a solid-liquid coexistence state in which a liquid phase and a solid phase coexist, then thixotropy is developed by rotation of a screw, and the obtained semi-solidified product is injected into a mold. According to such a thixotropic molding method, since fluidity of the semi-solidified product is enhanced by heating and shearing, a thin component or a component having a complicated shape can be formed as compared with a die casting method.

In the thixotropic molding method, for example, a chip-shaped molding material is used. For example, WO 2012/137907 discloses a molding chip in which a surface of a magnesium chip is coated with a carbon powder by adding 0.01 wt % to 3 wt % of carbon black to the magnesium chip and mixing them with a mixer. According to such a molding chip coated with the carbon powder, it is possible to enhance bending characteristics and tensile strength of a molded product produced by injection molding.

The molded product produced using the magnesium alloy chip described in WO 2012/137907 may be low in thermal conductivity. It is difficult to apply a molded product having low thermal conductivity to a component or the like that requires heat dissipation. Therefore, the thermal conductivity of a thixotropically molded product is required to be further improved.

In addition, there is room for improvement in rigidity in a thixotropically molded product produced using the molding chip described in WO 2012/137907. In particular, in order to use a thixotropically molded product for a housing of a transport device such as an automobile or a mobile device, it is necessary to further enhance the rigidity of the thixotropically molded product.

### SUMMARY

A thixotropically molded product according to an application example of the present disclosure includes: a matrix portion containing Mg as a main component; and carbon fibers dispersed in the matrix portion. An area fraction of the carbon fibers in a cross section is 1.0% or more and 30.0% or less.

A thixotropic molding material according to an application example of the present disclosure includes: a metal body containing Mg as a main component; a carbon fiber piece adhering to a surface of the metal body; and a bonding portion interposed between the metal body and the carbon fiber piece. A content of the carbon fiber piece is 1 mass? or more and 20 mass % or less.

### BRIEF DESCRIPTION OF THE DRAWINGS

FIG. 1 is a partial cross-sectional view schematically showing a thixotropically molded product according to a first embodiment.

FIG. 2 is a partial cross-sectional view schematically showing a thixotropically molded product according to a second embodiment.

FIG. 3 is a cross-sectional view showing an example of an injection molding machine used in a thixotropic molding method.

FIG. 4 is a cross-sectional view schematically showing a thixotropic molding material according to a third embodiment.

FIG. 5 is a partially enlarged view of FIG. 4.

FIG. 6 is a partially enlarged cross-sectional view schematically showing a thixotropic molding material according to a fourth embodiment.

FIG. 7 is a step diagram showing a method of producing a thixotropic molding material.

### DESCRIPTION OF EMBODIMENTS

Hereinafter, a thixotropically molded product and a thixotropic molding material according to the present disclosure will be described in detail based on embodiments shown in the accompanying drawings.

### 1. First Embodiment

First, a thixotropically molded product according to a first embodiment will be described.

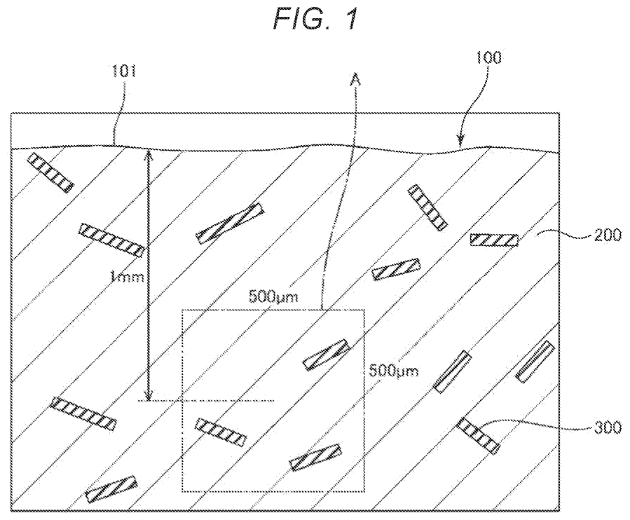

FIG. 1 is a partial cross-sectional view schematically showing a thixotropically molded product 100 according to the first embodiment.

The thixotropically molded product 100 shown in FIG. 1 includes a matrix portion 200 and carbon fibers 300 dispersed in the matrix portion 200. The matrix portion 200 contains Mg as a main component. The carbon fibers 300 contain carbon as a main component and each have a fibrous shape. Further, an area fraction of the carbon fibers 300 in a cross section of the thixotropically molded product 100 is 1.0% or more and 30.0% or less.

Such a thixotropically molded product 100 has high thermal conductivity. Specifically, the carbon fibers 300 provide high thermal conductivity to the thixotropically molded product 100 due to high thermal conductivity and a shape effect of carbon. In addition, the thixotropically molded product 100 has high rigidity. Specifically, the carbon fibers 300 provide high rigidity to the thixotropically molded product 100 due to a high elastic modulus and a shape effect of carbon. Therefore, the thixotropically molded product 100 is a molded product having both high thermal conductivity and high rigidity, and is suitably used for, for example, a member that requires heat dissipation and high rigidity.

### 1.1. Matrix Portion

The matrix portion 200 contains Mg as a main component. Containing Mg as a main component refers to that, when elemental analysis is performed on a cross section of the matrix portion 200, a content of Mg is the highest in terms of atomic ratio. For the elemental analysis, for example, a qualitative and quantitative analysis based on an energy dispersive X-ray spectroscopy (EDX) is used. The content of Mg in the matrix portion 200 may be higher than that of other elements, and is preferably more than 50 atomic, more preferably 70 atomic % or more, and still more preferably 80 atomic % or more. During identification of the matrix portion 200 in the qualitative and quantitative analysis, the matrix portion 200 can be distinguished based on a contrast with the carbon fibers 300 or a color tone in, for example, an observation image from a scanning electron microscope or an optical microscope.

The matrix portion 200 occupies the highest area fraction in the cross section of the thixotropically molded product 100. Therefore, the matrix portion 200 has a dominant influence on mechanical properties and thermal properties of the thixotropically molded product 100. Accordingly, high specific rigidity, high specific strength, and high toughness of Mg are reflected in the thixotropically molded product 100.

The matrix portion 200 may contain various additive components other than Mg. Examples of the additive components include lithium, beryllium, calcium, aluminum, silicon, manganese, iron, nickel, copper, zinc, strontium, yttrium, zirconium, silver, tin, gold, and rare earth elements, and one or a mixture of two or more of these components is used. Examples of the rare earth elements include cerium.

In particular, the additive component preferably contains both aluminum and zinc. Accordingly, when the thixotropically molded product 100 is produced by a thixotropic molding method, a melting point of a raw material decreases, and fluidity of the semi-solidified product is improved. As a result, moldability during the thixotropic molding is enhanced, and thus dimensional accuracy of the produced thixotropically molded product 100 can be enhanced.

A content of aluminum in the matrix portion 200 is, for example, preferably 5.0 mass % or more and 13.0 mass % or less, and more preferably 7.0 mass % or more and 11.0 mass % or less. A content of zinc is, for example, preferably 0.3 mass % or more and 3.0 mass % or less, and more preferably 0.5 mass % or more and 2.0 mass % or less.

In addition to aluminum and zinc, the additive component preferably contains at least one selected from the group consisting of silicon, manganese, yttrium, strontium, and rare earth elements. Accordingly, mechanical properties, corrosion resistance, wear resistance, and thermal conductivity of the thixotropically molded product 100 can be enhanced.

A composition of the matrix portion 200 may be a composition of a magnesium alloy defined in various standards. Examples of such a magnesium alloy include AZ91A, AZ91B, AZ91D, AM60A, AM60B, AS41A, AZ31, AZ31B, AZ61A, AZ63A, AZ80A, AZ91C, AZ91E, AZ92A, AM100A, ZK51A, ZK60A, ZK61A, EZ33A, QE22A, ZE41A, MIA, WE54A, and WE43B of the American Society for Testing and Materials (ASTM) standard. Among these, AZ91A, AZ91B, or AZ91D is preferably used. These magnesium alloys are useful because of well-balanced moldability, mechanical properties, and the like, and are excellent in corrosion resistance.

### 1.2. Carbon Fibers

As described above, the carbon fibers 300 contain carbon as a main component and have a fibrous shape. Containing carbon as a main component refers to that, when elemental analysis is performed on cross sections of the carbon fibers 300, a content of C is the highest in terms of atomic ratio. For the elemental analysis, for example, a qualitative and quantitative analysis based on an energy dispersive X-ray spectroscopy (EDX) is used. The content of C in the carbon fibers 300 may be higher than that of other elements, and is preferably more than 50 atomic %, more preferably 70 atomic % or more, and still more preferably 90 atomic % or more. During identification of the carbon fibers 300 in the qualitative and quantitative analysis, the carbon fibers 300 can be distinguished based on a contrast with the matrix portion 200 or a color tone in, for example, an observation image from a scanning electron microscope or an optical microscope. The carbon fibers 300 may contain additives or impurities other than carbon.

In addition, the term “fibrous shape” means that an average aspect ratio of the carbon fibers 300 in the cross section of the thixotropically molded product 100 is 1.2 or more. An aspect ratio of the carbon fibers 300 is a ratio of a length to a width of the carbon fibers 300 in the cross section of the thixotropically molded product 100. The length is a maximum length that can be taken in a cross section of the carbon fibers 300, and the width is a maximum length in a direction orthogonal to a direction of the maximum length. Then, 50 carbon fibers 300 are randomly extracted from the observation image of the cross section of the thixotropically molded product 100, and an average value of the aspect ratios of the carbon fibers 300 is the average aspect ratio. For example, an optical microscope or an electron microscope is used to acquire the observation image.

The average aspect ratio of the carbon fibers 300 in the cross-section of the thixotropically molded product 100 is preferably 1.5 or more and 20.0 or less, more preferably 2.0 or more and 15.0 or less, and still more preferably 3.0 or more and 10.0 or less. Accordingly, since the carbon fibers 300 have a larger shape effect, it is possible to impart higher thermal conductivity and higher rigidity to the thixotropically molded product 100. When the average aspect ratio of the carbon fibers 300 is less than the above lower limit value, the shape effect of the carbon fibers 300 is reduced, and thus the thermal conductivity and the rigidity of the thixotropically molded product 100 may not be sufficiently enhanced. On the other hand, when the average aspect ratio of the carbon fibers 300 is more than the above upper limit value, dispersibility of the carbon fibers 300 in the matrix portion 200 decreases, and thus the above-described effect may not be sufficiently obtained or the effect may be uneven.

In the observation image of the cross section of the thixotropically molded product 100 shown in FIG. 1, a range A of 500 μm square is set around a point at a depth of 1 mm from a surface 101. A proportion of an area of the carbon fibers 300 to an area of the range A is defined as an area fraction S3 of the carbon fibers 300.

At this time, the area fraction S3 is 1.0% or more and 30.0% or less as described above. By setting the area fraction S3 within the above range, the above-described effect by the carbon fibers 300, specifically, the effect of enhancing the thermal conductivity and the rigidity of the thixotropically molded product 100 can be obtained. Therefore, when the area fraction S3 is less than the above lower limit value, the carbon fibers 300 are insufficient, and thus the above-described effect cannot be obtained. On the other hand, when the area fraction S3 is more than the above upper limit value, the carbon fibers 300 are excessive, resulting in a decrease in “toughness” of the thixotropically molded product 100. The area fraction S3 is preferably 5.0% or more and 28.0% or less, and more preferably 8.0% or more and 26.0% or less.

The area fraction S3 in the range A is calculated as follows. First, a range of the carbon fibers 300 is extracted by image processing in the range A. For the image processing, for example, image analysis software OLYMPUS Stream or the like can be used. A magnification of the observation image is preferably 300 times or more. Next, a proportion of the area of the carbon fibers 300 to the entire area of the range A is calculated. The proportion is defined as the area fraction S3.

An average fiber length of the carbon fibers 300 in the cross-section of the thixotropically molded product 100 is preferably 15 μm or more and 150 μm or less, more preferably 30 μm or more and 90 μm or less, and still more preferably 50 μm or more and 85 μm or less. Accordingly, the carbon fibers 300 have good dispersibility in the matrix portion 200 and exhibit a sufficient shape effect. As a result, high thermal conductivity and high rigidity can be obtained in the entire thixotropically molded product 100, and occurrence of unevenness in the characteristics can be prevented.

A fiber length of the carbon fibers 300 is the above-described length of the carbon fibers 300 in the cross section of the thixotropically molded product 100. Then, 50 carbon fibers 300 are randomly extracted from the observation image cross of the section of the thixotropically molded product 100, and an average value of the fiber lengths of the carbon fibers 300 is the average fiber length. For example, an optical microscope or an electron microscope is used to acquire the observation image.

An average fiber width of the carbon fibers 300 in the cross-section of the thixotropically molded product 100 is preferably 2 μm or more and 20 μm or less, more preferably 3 μm or more and 15 μm or less, and still more preferably 5 μm or more and 12 μm or less. Accordingly, the carbon fibers 300 have high elasticity and high thermal conductivity, and have good dispersibility in the matrix portion 200.

A fiber width of the carbon fibers 300 is the above-described width of the carbon fibers 300 in the cross section of the thixotropically molded product 100. Then, 50 carbon fibers 300 are randomly extracted from the observation image of the cross section of the thixotropically molded product 100, and an average value of the fiber widths of the carbon fibers 300 is the average fiber width. For example, an optical microscope or an electron microscope is used to acquire the observation image.

The carbon fiber 300 may be any fiber as long as the fiber contains carbon as a main component and includes a fine graphite crystal structure. Specific examples of the carbon fibers 300 include PAN-based carbon fibers, pitch-based carbon fibers, and rayon-based carbon fibers. Among these, one type or a mixture of two or more types thereof is used.

Among these, the PAN-based carbon fibers have characteristics such as high tensile strength, while the pitch-based carbon fibers have characteristics such as a high elastic modulus. Therefore, the type of the carbon fibers 300 may be selected according to the mechanical properties desired to be imparted to the thixotropically molded product 100.

The carbon fibers 300 have excellent mechanical properties and thermal properties derived from the graphite crystal structure.

For example, a tensile elastic modulus of the carbon fibers 300 is preferably 150 GPa or more, and more preferably 200 GPa or more. Accordingly, the carbon fibers 300 can impart particularly high rigidity to the thixotropically molded product 100. An upper limit value of the tensile elastic modulus of the carbon fibers 300 may not be particularly set, and is preferably 1200 GPa in consideration of production stability of the carbon fibers 300.

The tensile elastic modulus of the carbon fibers 300 is measured according to, for example, a test method defined in JIS R 7606:2000.

In addition, a thermal conductivity of the carbon fibers 300 in a fiber length direction is preferably 200 W/(m·K) or more, and more preferably 400 W/(m·K) or more. Accordingly, the carbon fibers 300 can impart particularly high thermal conductivity to the thixotropically molded product 100. An upper limit value of the thermal conductivity of the carbon fibers 300 not be may particularly set, and is preferably 1200 W/(m·K) in consideration of the production stability of the carbon fibers 300.

Although the thixotropically molded product 100 according to the first embodiment is described above, additives other than the matrix portion 200 and the carbon fibers 300 may be contained in the cross section. Examples of the additives include a metal powder other than Mg, a ceramic powder, a carbon powder, and a silicon powder. In this case, an area fraction of the additives in the cross section of the thixotropically molded product 100 is preferably lower than the area fraction of the carbon fibers 300, more preferably 20.0% or less, and still more preferably 10.0% or less.

### 1.3. Physical Properties of Thixotropically Molded Product

A tensile elastic modulus (Young's modulus) of the thixotropically molded product 100 is preferably 40 GPa or more, and more preferably 45 GPa or more. The thixotropically molded product 100 having a tensile elastic modulus within the above range has particularly high specific rigidity. Since such a thixotropically molded product 100 is lightweight and has high rigidity, the thixotropically molded product 100 is suitable for, for example, a component used for a transportation device such as an automobile and an aircraft, a component used in a mobile device such as a mobile terminal and a notebook computer, and a movable component such as a robot arm.

The tensile elastic modulus of the thixotropically molded product 100 is measured as follows. First, a test piece is cut out from the thixotropically molded product 100. Next, the test piece is attached to a tensile tester, and a tensile load is applied to the test piece at 25° C. Next, an amount of change in tensile strain when the tensile load is varied and an amount of change in tensile stress when the tensile load is varied are calculated. Then, a ratio of the latter amount of change to the former amount of change is calculated, and the obtained ratio is defined as the tensile elastic modulus of the thixotropically molded product 100. The tensile elastic modulus of the thixotropically molded product 100 may be a value measured by a method other than the above-described measurement method, for example, a resonance method or an ultrasonic pulse method.

Tensile strength of the thixotropically molded product 100 is preferably 180 MPa or more, and more preferably 190 MPa or more. Further, a 0.2% proof stress of the thixotropically molded product 100 is preferably 155 MPa or more, and more preferably 165 MPa or more.

The thixotropically molded product 100 in which the tensile strength and the 0.2% proof stress are within the above ranges has particularly high specific strength. Since such a thixotropically molded product 100 is lightweight and has high strength, the thixotropically molded product 100 is suitable for, for example, a component used for a transportation device such as an automobile and an aircraft, a component used in a mobile device such as a mobile terminal and a notebook computer, and a movable component such as a robot arm.

The tensile strength and the 0.2% proof stress of the thixotropically molded product 100 are measured as follows. First, a test piece is cut out from the thixotropically molded product 100. Examples of the test piece include a No. 13 test piece defined in JIS. Next, the test piece is attached to a tensile tester, and a stress corresponding to a maximum force applied to the test piece at 25° C. is calculated. The obtained stress is defined as the tensile strength of the thixotropically molded product 100. In addition, in a stress-strain curve obtained by measurement, a stress corresponding to a point of 0.2% strain is defined as the 0.2% proof stress.

Vickers hardness of a surface of the thixotropically molded product 100 is preferably 65 or more, more preferably 70 or more, and still more preferably 80 or more. When the Vickers hardness is within the above range, it is possible to obtain the thixotropically molded product 100 having high surface hardness and being resistant to scratches and the like. The Vickers hardness of the surface of the thixotropically molded product 100 is measured according to a Vickers hardness test method defined in JIS Z 2244:2009. A measurement load is 5 kgf.

A thermal conductivity of the thixotropically molded product 100 is preferably 53 W/(m·K) or more, more preferably 58 W/(m·K) or more, and still more preferably 62 W/(m·K) or more. The thixotropically molded product 100 having such a thermal conductivity can also be applied to, for example, a site where heat dissipation is required.

The thermal conductivity of the thixotropically molded product 100 is measured by, for example, a laser flash method.

### 1.4. Effects of First Embodiment

As described above, the thixotropically molded product 100 according to the first embodiment includes the matrix portion 200 and the carbon fibers 300. The matrix portion 200 contains Mg as a main component. The carbon fibers 300 are dispersed in the matrix portion 200. Further, the area fraction S3 of the carbon fibers 300 in the cross section of the thixotropically molded product 100 is 1.0% or more and 30.0% or less.

According to such a configuration, a high thermal conductivity, a high elastic modulus, and a shape effect of the carbon fibers 300 can be added in addition to high specific rigidity of the matrix portion 200. As a result, it is possible to implement the thixotropically molded product 100 having high thermal conductivity and high rigidity. In addition, by setting the area fraction S3 within the above range, it is possible to prevent a failure due to shortage or excess of the carbon fibers 300.

The average fiber length of the carbon fibers 300 is preferably 15 μm or more and 150 μm or less.

Accordingly, the carbon fibers 300 have good dispersibility in the matrix portion 200 and exhibit a sufficient shape effect. As a result, high thermal conductivity and high rigidity can be obtained in the entire thixotropically molded product 100, and occurrence of unevenness in the characteristics can be prevented.

In addition, the average aspect ratio of the carbon fibers 300 is preferably 1.5 or more and 20.0 or less.

Accordingly, since the carbon fibers 300 have a larger shape effect, it is possible to impart higher thermal conductivity and higher rigidity to the thixotropically molded product 100.

### 2. Second Embodiment

Next, a thixotropically molded product according to a second embodiment will be described.

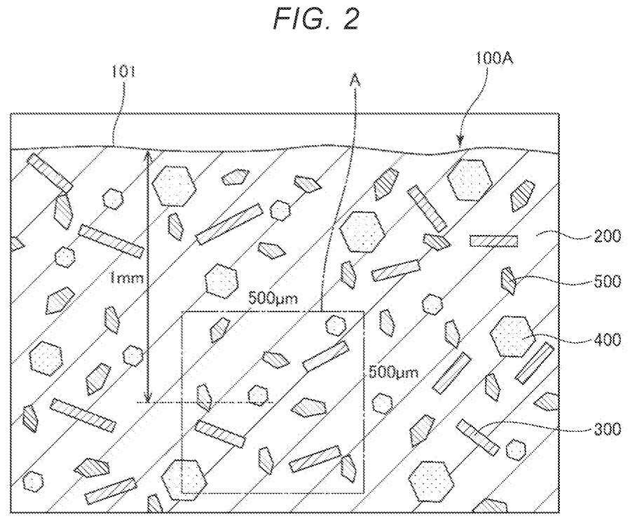

FIG. 2 is a partial cross-sectional view schematically showing a thixotropically molded product 100A according to the second embodiment.

Hereinafter, the second embodiment will be described, and in the following description, differences from the first embodiment will be mainly described, and description of similar matters will be omitted. In FIG. 2, the same components as those in FIG. 1 are denoted by the same reference numerals.

The thixotropically molded product 100A shown in FIG. 2 includes first Mg particle portions 400 and second Mg particle portions 500 dispersed in the matrix portion 200 in addition to the matrix portion 200 and the carbon fibers 300.

### 2.1. First Mg Particle Portion

The first Mg particle portions 400 contain Mg₂Si as a main component, and have a particulate shape. Mg₂Si has a tensile elastic modulus (Young's modulus) higher than that of the matrix portion 200. Therefore, the first Mg particle portions 400 function as a reinforcing material for enhancing rigidity of the thixotropically molded product 100A. Accordingly, the thixotropically molded product 100A has higher rigidity.

Containing Mg₂Si as a main component refers to that, when elemental analysis is performed on cross sections of the first Mg particle portions 400, a content of Mg is the highest and a content of Si is the second highest in terms of atomic ratio. For the elemental analysis, for example, a qualitative and quantitative analysis based on an energy dispersive X-ray spectroscopy (EDX) is used. A total content of Mg and Si in the first Mg particle portions 400 may be higher than that of other elements, and is preferably more than 50 atomic %, and more preferably 60 atomic % or more. During identification of the first Mg particle portions 400 in the qualitative and quantitative analysis, the first Mg particle portions 400 can be distinguished based on a contrast with the matrix portion 200 or the carbon fibers 300 or a color tone in, for example, an observation image from a scanning electron microscope or an optical microscope. The first Mg particle portions 400 may contain additives or impurities other than Mg₂Si.

The first Mg particle portions 400 also have a function of preventing coarsening of Mg crystals contained in the matrix portion 200. Therefore, in the thixotropically molded product 100A, refinement of the Mg crystals in the matrix portion 200 is achieved. Accordingly, the thixotropically molded product 100A has high mechanical strength.

A cross-sectional shape of the first Mg particle portion 400 is not particularly limited and may be any shape, and an average aspect ratio thereof is preferably less than 2.0, and more preferably 1.5 or less. Accordingly, the first Mg particle portions 400 are less likely to become a starting point that causes a crack in the thixotropically molded product 100A, and thus an effect of enhancing the mechanical strength of the thixotropically molded product 100A is obtained. In addition, the effect of preventing coarsening of the Mg crystals is more remarkable.

An aspect ratio of the first Mg particle portions 400 is a ratio of a length to a width of the first Mg particle portions 400 in a cross section of the thixotropically molded product 100A. The length is a maximum length that can be taken in a cross section of the first Mg particle portion 400, and the width is a maximum length in a direction orthogonal to a direction of the maximum length. Then, ten first Mg particle portions 400 are randomly extracted from the observation image of the cross section of the thixotropically molded product 100A, and an average value of the aspect ratios of the first Mg particle portions is the average aspect ratio. For example, an optical microscope or an electron microscope is used to acquire the observation image.

### 2.2. Second Mg Particle Portion

The second Mg particle portions 500 contain MgO as a main component, and have a particulate shape. MgO has a tensile elastic modulus (Young's modulus) higher than that of the matrix portion 200. Therefore, the second Mg particle portions 500 function as a reinforcing material for enhancing the rigidity of the thixotropically molded product 100A. Accordingly, the thixotropically molded product 100A has higher rigidity.

Containing MgO as a main component refers to that, when elemental analysis is performed on cross sections of the second Mg particle portions 500, a content of one of Mg and O is the highest and a content of the other is the second highest in terms of atomic ratio. For the elemental analysis, for example, a qualitative and quantitative analysis based on an energy dispersive X-ray spectroscopy (EDX) is used. A total content of Mg and O in the second Mg particle portions 500 may be higher than that of other elements, and is preferably more than 50 atomic %, and more preferably 60 atomic % or more. During identification of the second Mg particle portions 500 in the qualitative and quantitative analysis, the second Mg particle portions 500 can be distinguished based on a contrast with the matrix portion 200 or the carbon fibers 300, or the first Mg particle portions 400, or a color tone in, for example, an observation image from a scanning electron microscope or an optical microscope. The second Mg particle portions 500 may contain additives or impurities other than MgO.

The second Mg particle portions 500 also have a function of preventing coarsening of the Mg crystals contained in the matrix portion 200. Therefore, in the thixotropically molded product 100A, refinement of the Mg crystals in the matrix portion 200 is achieved. Accordingly, the thixotropically molded product 100A has high mechanical strength.

Further, the second Mg particle portions 500 further have a function of inhibiting abnormal growth of the first Mg particle portions 400 in a branch shape or a needle shape. Due to the function, the first Mg particle portions 400 tend to have an isotropic shape, and an increase in average aspect ratio is prevented.

### 2.3. Interrelationship of Particle Portions

In the observation image of the cross section of the thixotropically molded product 100A shown in FIG. 2, the range A of 500 μm square is set around a point at a depth of 1 mm from the surface 101. A proportion (area fraction) of an area of the first Mg particle portions 400 to an area of the range A is defined as S1, and a proportion (area fraction) of an area of the second Mg particle portions 500 to the area of the range A is defined as S2.

At this time, a total of the area fraction S1 and the area fraction S2 is preferably 0.2% or more and 30.0% or less, more preferably 0.5% or more and 10.0% or less, and still more preferably 1.0% or more and 5.0% or less. Accordingly, the area fractions of the first Mg particle portions 400 and the second Mg particle portions 500 functioning as the reinforcing material are optimized, and the rigidity of the thixotropically molded product 100A can be particularly enhanced. In addition, since the effect of preventing coarsening of the Mg crystals by the first Mg particle portions 400 and the second Mg particle portions 500 is further improved, the thixotropically molded product 100A having particularly high mechanical strength can be obtained.

A ratio S1/S2 of the area fraction S1 to the area fraction S2 is preferably 0.5 or more and 4.0 or less, more preferably 1.0 or more and 2.5 or less, and still more preferably 1.1 or more and 2.0 or less. Accordingly, the function of the second Mg particle portions 500 that inhibits abnormal growth of the first Mg particle portions 400 is further enhanced.

The area fraction S1 and the area fraction S2 in the range A are calculated as follows. First, in the range A, the range of the first Mg particle portions 400 and the range of the second Mg particle portions 500 are extracted by image processing, and a total area thereof is calculated. For the image processing, for example, image analysis software OLYMPUS Stream or the like can be used. A magnification of the observation image is preferably 300 times or more. Next, a proportion of the area of the first Mg particle portions 400 and a proportion of the area of the second Mg particle portions 500 to the entire area of the range A are calculated. The proportions are the area fraction S1 and the area fraction S2.

In the range A, the total of the area fraction S1 and the area fraction S2 is defined as S1+S2. At this time, a ratio of S3/(S1+S2) is preferably 2.0 or more and 50.0 or less, more preferably 3.0 or more and 30.0 or less, and still more preferably 4.0 or more and 20.0 or less. By setting the ratio of S3/(S1+S2) within the above range, a quantitative balance between the carbon fibers 300 and the first Mg particle portions 400 and the second Mg particle portions 500 is improved. Accordingly, it is possible to implement the thixotropically molded product 100A in which the effects of the carbon fibers 300 and the effects of the first Mg particle portions 400 and the second Mg particle portions 500 do not interfere with each other. Such a thixotropically molded product 100A has particularly high thermal conductivity and high rigidity.

In addition, an average particle diameter of the first Mg particle portions 400 is defined as D1, and an average particle diameter of the second Mg particle portions 500 is defined as D2. The average particle diameters D1 and D2 are each preferably 0.1 μm or more and 10.0 μm or less, and more preferably 0.1 μm or more and 5.0 μm or less. When the average particle diameters D1 and D2 are within the above range, the first Mg particle portions 400 and the second Mg particle portions 500 are less likely to become starting points of cracks or the like even when contained in the thixotropically molded product 100A. Accordingly, the rigidity can be enhanced without impairing the mechanical strength of the thixotropically molded product 100A.

The average particle diameters D1 and D2 are calculated as follows. First, in the range A, particle diameters of the first Mg particle portions 400 and particle diameters of the second Mg particle portions 500 are both measured. The particle diameters of the first Mg particle portions 400 are intermediate values between a length of the major axis and a length of the minor axis in the cross sections of the first Mg particle portions 400. The average value of the particle diameters calculated in this manner is the average particle diameter D1 of the first Mg particle portions 400. The particle diameters of the second Mg particle portions 500 are intermediate values between a length of the major axis and a length of the minor axis in the cross sections of the second Mg particle portions 500. An average value of the particle diameters calculated in this manner is the average particle diameter D2 of the second Mg particle portions 500.

### 3. Thixotropic Molding Method

Next, an example of a thixotropic molding method of producing a thixotropically molded product will be described.

The thixotropic molding method is a molding method in which a pellet-shaped or chip-shaped raw material is heated in a cylinder to bring the material into a solid-liquid coexistence state in which a liquid phase and a solid phase coexist, then thixotropy is developed by rotation of a screw, and the obtained semi-solidified product is injected into a mold. According to such a thixotropic molding method, since fluidity of the semi-solidified product is enhanced by heating and shearing, a thin component or a component having a complicated shape can be formed as compared with, for example, a die casting method.

The thixotropically molded product described above is a molded product containing magnesium as a main component. Therefore, a material containing magnesium as a main component is used as a raw material.

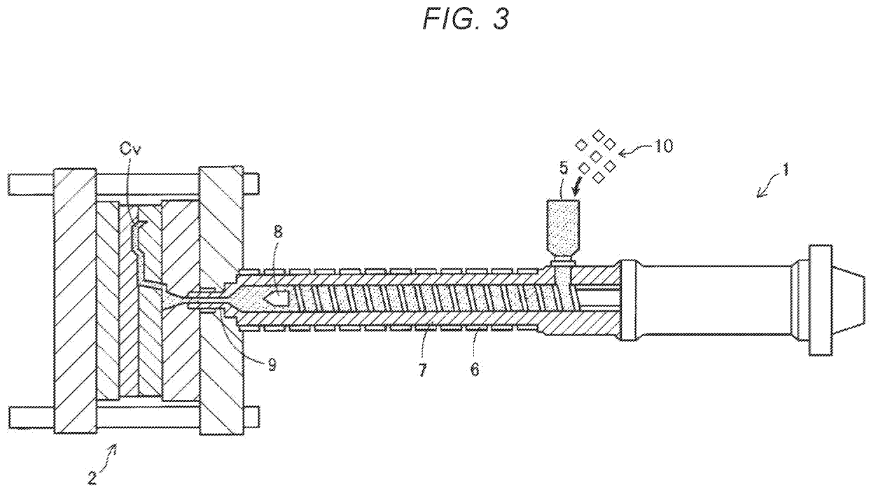

FIG. 3 is a cross-sectional view showing an example of an injection molding machine used for the thixotropic molding method.

As shown in FIG. 3, an injection molding machine 1 includes a mold 2, a hopper 5, a heating cylinder 7, a screw 8, and a nozzle 9. A cavity Cv is formed in the mold 2. When a thixotropic molding material 10 is charged into the hopper 5, the thixotropic molding material 10 is supplied to the heating cylinder 7. The thixotropic molding material 10 supplied to the heating cylinder 7 is heated by a heater 6 and conveyed while being sheared by the screw 8. Accordingly, the thixotropic molding material 10 is semi-melted and slurried. The obtained slurry is injected into the cavity Cv in the mold 2 through the nozzle 9 without being exposed to the atmosphere. Then, the slurry injected into the cavity Cv is cooled to obtain a thixotropically molded product.

The hopper 5 may be charged with other materials together with the thixotropic molding material 10.

### 4. Third Embodiment

Next, a thixotropic molding material according to a third embodiment will be described.

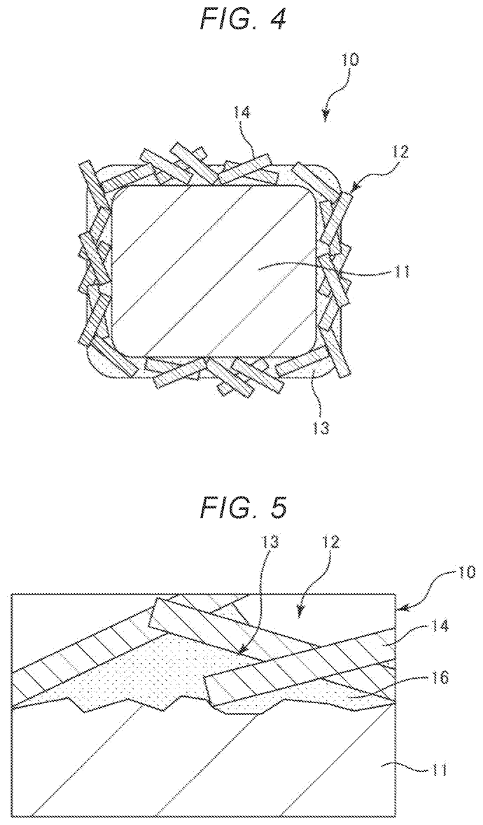

FIG. 4 is a cross-sectional view schematically showing the thixotropic molding material 10 according to the third embodiment. FIG. 5 is a partially enlarged view of FIG. 4.

The thixotropic molding material 10 shown in FIG. 4 includes a chip-shaped metal body 11, a coating portion 12 provided on a surface of the metal body 11, and a bonding portion 13 interposed between the metal body 11 and the coating portion 12.

As shown in FIG. 4, the coating portion 12 includes a plurality of carbon fiber pieces 14. The carbon fiber pieces 14 are provided on the surface of the metal body 11. The carbon fiber pieces 14 are short fibers of carbon fibers. Specific examples of the carbon fiber pieces 14 include chopped carbon fibers and milled carbon fibers. The carbon fibers 300 of the thixotropically molded product 100 described above are mainly derived from the carbon fiber pieces 14.

As shown in FIG. 5, the bonding portion 13 is an organic binder 16 interposed between the metal body 11 and the carbon fiber pieces 14. As shown in FIG. 5, the bonding portion 13 penetrates between the metal body 11 and the carbon fiber pieces 14 and between the carbon fiber pieces 14, and acts to bond them.

By performing thixotropic molding using such a thixotropic molding material 10, falling off of the carbon fiber pieces 14 is prevented by an action of the bonding portion 13. Therefore, a semi-molten material of the metal body 11 and the carbon fiber pieces 14 are likely to be uniformly mixed in the heating cylinder 7. Accordingly, the carbon fiber pieces 14 are uniformly dispersed in the semi-molten material. As a result, as shown in FIG. 1, it is possible to produce the thixotropically molded product 100 containing the carbon fibers 300 dispersed in the matrix portion 200.

A content of the carbon fiber pieces 14 in the thixotropic molding material 10 is the same as the area fraction S3 of the carbon fibers 300 in the thixotropically molded product 100 described above. The content of the carbon fiber pieces 14 in the thixotropic molding material 10 can be 1 mass % or more and 20 mass % or less. In addition, the content of the carbon fiber pieces 14 is preferably 5 mass % or more and 18 mass % or less, and more preferably 8 mass % or more and 15 mass % or less.

### 4.1. Metal Body

The metal body 11 is, for example, a section obtained by machining or cutting an Mg-based alloy cast with a mold or the like. A method of producing the metal body 11 is not limited thereto.

A material containing Mg as a main component is used as a constituent material of the metal body 11. The metal body 11 mainly generates the matrix portion 200 that the thixotropically molded product 100 includes.

The above-described additive component may be present in a form of a simple substance, an alloy, an oxide, an intermetallic compound, and the like in the metal body 11. The additive component may be segregated or uniformly dispersed in a crystal grain boundary of a metal structure such as Mg or an Mg alloy in the metal body 11.

An average particle diameter of the metal body 11 is not particularly limited, and is preferably 0.5 mm or more, and more preferably 1.5 mm or more and 10.0 mm or less. By setting the average particle diameter within the above range, generation of bridges and the like in the heating cylinder 7 of the injection molding machine 1 can be prevented.

The average particle diameter of the metal body 11 is an average value of diameters of circles having an area same as a projected area of the metal body 11. The average value is calculated based on 100 or more randomly selected metal bodies 11.

An average aspect ratio of the metal body 11 is preferably 5.0 or less, and more preferably 4.0 or less. In the metal body 11 having such an average aspect ratio, a filling property in the heating cylinder 7 is enhanced and temperature uniformity during heating is improved. As a result, the thixotropically molded product 100 having high mechanical properties and high dimensional accuracy can be obtained.

The average aspect ratio of the metal body 11 is an average value of aspect ratios calculated from major axis/minor axis in a projection image of the metal body 11. The average value is calculated based on 100 or more randomly selected metal bodies 11. The major axis is a maximum length that can be taken in the projection image, and the minor axis is a maximum length in a direction orthogonal to the major axis.

The metal body 11 may be subjected to any surface treatment as necessary. Examples of the surface treatment include a plasma treatment, a corona treatment, an ozone treatment, an ultraviolet irradiation treatment, and a roughening treatment.

### 4.2. Coating Portion

The coating portion 12 includes the plurality of carbon fiber pieces 14. In the embodiment, as shown in FIG. 4, the plurality of carbon fiber pieces 14 are distributed to cover the surface of the metal body 11, thereby forming the coating portion 12. The coating portion 12 preferably covers the entire surface of the metal body 11, or may cover only a part of the surface.

The carbon fiber pieces 14 are dispersed in the semi-molten material when subjected to the thixotropic molding. The carbon fiber pieces 14 are less likely to vaporize during the thixotropic molding, and can be prevented from causing molding defects.

A constituent material, an average aspect ratio, an average fiber length, and an average fiber diameter of the carbon fiber pieces 14 are the same as the constituent material, the average aspect ratio, the average fiber length, and the average fiber width of the carbon fibers 300 described above.

For example, the average fiber length of the carbon fiber pieces 14 is preferably 15 μm or more and 150 μm or less, more preferably 30 μm or more and 90 μm or less, and still more preferably 50 μm or more and 85 μm or less. Accordingly, the average fiber length of the carbon fibers 300 described above can be optimized in the carbon fiber pieces 14. In addition, when the carbon fiber pieces 14 adhere to the surface of the metal body 11, the carbon fiber pieces 14 can be uniformly distributed, and the carbon fiber pieces 14 are less likely to fall off. When the average fiber length of the carbon fiber pieces 14 is more than the above upper limit value, the carbon fiber pieces 14 may form a lump or the carbon fiber pieces 14 may be likely to fall off.

An addition amount of the carbon fiber pieces 14 with respect to the metal body 11 is appropriately set according to an abundance ratio between the matrix portion 200 and the carbon fibers 300 of the thixotropically molded product 100 to be produced.

The coating portion 12 may contain a substance other than the carbon fiber pieces 14. In this case, a content of the substance other than the carbon fiber pieces 14 may be less than the content of the carbon fiber pieces 14 in terms of mass ratio, and is preferably 20 mass % or less, and more preferably 10 mass % or less of the carbon fiber pieces 14.

In addition, the carbon fiber piece 14 may be a mixed fiber piece obtained by mixing two or more types of carbon fiber pieces having different constituent materials.

Further, the carbon fiber pieces 14 may be subjected to any surface treatment as necessary. Examples of the surface treatment include a plasma treatment, a corona treatment, an ozone treatment, an ultraviolet irradiation treatment, a roughening treatment, and a coupling agent treatment.

### 4.3. Bonding Portion

The bonding portion 13 contains the organic binder 16, and is interposed between the metal body 11 and the carbon fiber pieces 14 or between the carbon fiber pieces 14, as shown in FIG. 5.

Examples of the organic binder 16 include various resins, waxes, alcohols, higher fatty acids, fatty acid metals, higher fatty acid esters, higher fatty acid amides, nonionic surfactants, and silicone-based lubricants. The various resins include: polyolefins such as a polyethylene, a polypropylene, and an ethylene-vinyl acetate copolymer; acrylic resins such as polymethyl methacrylate and polybutyl methacrylate; styrene-based resins such as a polystyrene; polyesters such as polyvinyl chloride, polyvinylidene chloride, polyamide, polyethylene terephthalate, and polybutylene terephthalate; a polyether; polyvinyl alcohol; polyvinyl pyrolidone; or copolymers thereof. The organic binder 16 may be a mixture containing at least one of the above components and another component, or may be a mixture containing two or more of the above components.

Among these, the organic binder 16 preferably contains waxes, and more preferably contains a paraffin wax or a derivative thereof. The wax has good binding capacity.

Examples of the waxes include natural waxes and synthetic waxes. The natural waxes include: a plant wax such as a candelilla wax, a carnauba wax, a rice wax, a Japan wax, and jojoba oil; an animal wax such as a beeswax, lanolin, and spermaceti; a mineral wax such as a Montan wax, ozokerite, and ceresin; and a petroleum wax such as a paraffin wax, a microcrystalline wax, and petrolatum. The synthetic waxes include: a synthetic hydrocarbon such as a polyethylene wax, a modified wax such as Montan wax derivatives, paraffin wax derivatives, and microcrystalline wax derivatives; a hydrogenated wax such as hardened castor oil and hardened castor oil derivatives; a fatty acid such as 12-hydroxystearic acid; acid amide such as stearamide; and an ester such as phthalic anhydride ester.

### 4.4. Effects of Third Embodiment

As described above, the thixotropic molding material 10 according to the third embodiment includes the metal body 11, the carbon fiber pieces 14, and the bonding portion 13. The metal body 11 contains Mg as a main component. The carbon fiber pieces 14 adhere to the surface of the metal body 11. The bonding portion 13 is interposed between the metal body 11 and the carbon fiber pieces 14. Further, the content of the carbon fiber pieces 14 is 1 mass % or more and 20 mass % or less.

According to such a thixotropic molding material 10, the high thermal conductivity, the high elastic modulus, and the shape effect of the carbon fiber pieces 14 are added in addition to the high specific rigidity of the metal body 11. As a result, the thixotropic molding material 10 with which the thixotropically molded product 100 having high thermal conductivity and high rigidity can be produced is obtained.

The average fiber length of the carbon fiber pieces 14 is preferably 15 μm or more and 150 μm or less. Accordingly, the average fiber length of the carbon fibers 300 in the produced thixotropically molded product 100 can be optimized. As a result, the thixotropic molding material 10 with which the thixotropically molded product 100 having particularly high thermal conductivity and high rigidity can be produced is obtained. In addition, when the carbon fiber pieces 14 adhere to the surface of the metal body 11, the carbon fiber pieces 14 can be uniformly distributed, and the carbon fiber pieces 14 are less likely to fall off.

### 5. Fourth Embodiment

Next, a thixotropic molding material according to a fourth embodiment will be described.

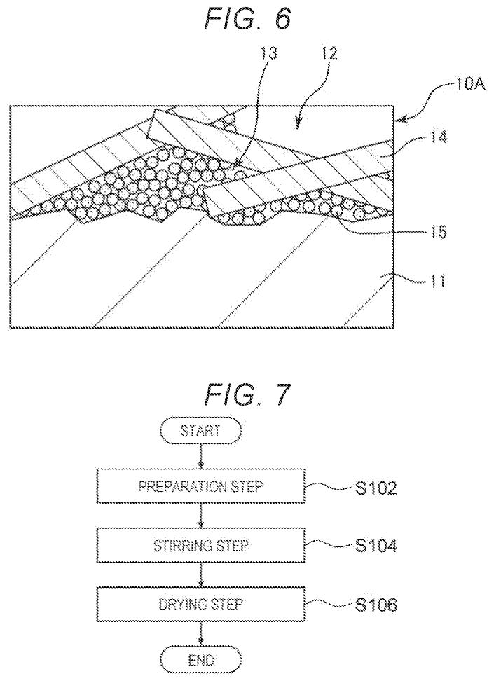

FIG. 6 is a partially enlarged cross-sectional view schematically showing a thixotropic molding material 10A according to the fourth embodiment.

Hereinafter, the fourth embodiment will be described, and in the following description, differences from the third embodiment will be mainly described, and description of similar matters will be omitted. In FIG. 6, the same components as those in the third embodiment are denoted by the same reference numerals as those in FIGS. 4 and 5.

The thixotropic molding material 10A shown in FIG. 6 is the same as the thixotropic molding material 10 shown in FIGS. 4 and 5 except that the configuration of the bonding portion 13 is different.

The bonding portion 13 shown in FIG. 6 includes interposed particles 15 in the form of particles, instead of the organic binder 16 shown in FIGS. 4 and 5. As shown in FIG. 6, the interposed particles 15 penetrate between the metal body 11 and the carbon fiber pieces 14 and between the carbon fiber pieces 14, and act to bond them.

The interposed particles 15 are particles having an average particle diameter smaller than the average fiber diameter of the carbon fiber pieces 14 and containing a silicon oxide as a main component. In the present specification, the “silicon oxide” refers to a substance represented by a composition formula of SiOₓ (0<x≤2). Since such interposed particles 15 are minute, the interposed particles 15 easily enter between the metal body 11 and the carbon fiber pieces 14 or between the carbon fiber pieces 14. It is considered that the interposed particles 15 strongly interact with both the metal body 11 and the carbon fiber pieces 14 since the interposed particles 15 have a very large specific surface area. Examples of the interaction include an intermolecular force such as a hydrogen bond and a Van Der Waals force, and an anchor effect caused by an aggregate of the interposed particles 15 entering irregularities present on the surface of the metal body 11. In particular, hydroxy groups are present in a high density on surfaces of the interposed particles 15 containing the silicon oxide. The hydroxy group forms a hydrogen bond with the metal body 11 and the carbon fiber pieces 14, which is considered to be a driving force for the interaction. Due to such interaction, the bonding portion 13 has a function of fixing the carbon fiber pieces 14 to the surface of the metal body 11.

In the thixotropic molding material 10A including such a bonding portion 13, the carbon fiber pieces 14 are less likely to fall off because the metal body 11 and the carbon fiber pieces 14 are more firmly fixed to each other via the interposed particles 15. Therefore, when the thixotropic molding material 10A is charged into the heating cylinder 7 during the thixotropic molding, the semi-molten material of the metal body 11 and the carbon fiber pieces 14 are likely to be uniformly mixed. Accordingly, the carbon fiber pieces 14 and the interposed particles 15 can be uniformly dispersed in the thixotropically molded product 100A.

The silicon oxide contained in the interposed particles 15 is less likely to be vaporized, and is combined with magnesium when incorporated into the thixotropically molded product 100A, to generate the first Mg particle portions 400 and the second Mg particle portions 500 which function as the reinforcing material described above. Therefore, occurrence of molding defects due to vaporization is prevented, and the thixotropically molded product 100A having excellent mechanical properties is obtained.

Containing the silicon oxide as a main component refers to that, when the elemental analysis is performed on the interposed particles 15, a content of one of Si and O is the highest and a content of the other is the second highest in terms of atomic ratio. For the elemental analysis, for example, a qualitative and quantitative analysis based on an energy dispersive X-ray spectroscopy (EDX) is used. A total content of Si and O in the interposed particles 15 may be higher than that of other elements, and is preferably more than 50 atomic %, more preferably 60 atomic % or more, and still more preferably 80 atomic % or more.

The interposed particles 15 may contain impurities in addition to the silicon oxide. An allowable amount of the impurities is preferably 30 mass % or less, and more preferably 10 mass % or less of the interposed particles 15. Accordingly, inhibition of the effect due to the impurities is sufficiently reduced.

The interposed particles 15 may be particles containing an inorganic oxide. Examples of the inorganic oxide include an aluminum oxide and a zirconium oxide, and a composite material containing at least one of these component may be used.

As described above, the average particle diameter of the interposed particles 15 may be smaller than the average fiber diameter of the carbon fiber pieces 14. Specifically, the average particle diameter of the interposed particles 15 is preferably 20% or less, more preferably 10% or less, and still more preferably 5% or less of the average fiber diameter of the carbon fiber pieces 14. Accordingly, the interposed particles 15 are particularly likely to enter between the metal body 11 and the carbon fiber pieces 14 and between the carbon fiber pieces 14. The specific surface area of the interposed particles 15 is also particularly large.

The lower limit value may not necessarily be set, and is preferably 0.01% or more, more preferably 0.05% or more, and still more preferably 0.10% or more of the carbon fiber pieces 14 from the viewpoint of easy aggregation of the interposed particles 15 and difficulty in handling of the interposed particles 15.

The average particle diameter of the interposed particles 15 is preferably 1 nm or more and 100 nm or less, more preferably 10 nm or more and 80 nm or less, and still more preferably 20 nm or more and 60 nm or less. When the average particle diameter is within the above range, the interposed particles 15 are particularly likely to enter between the metal body 11 and the carbon fiber pieces 14 or between the carbon fiber pieces 14. The specific surface area of the interposed particles 15 is also particularly large. Further, when the average particle diameter is within the above range, aggregation of the interposed particles 15 is prevented.

The average particle diameter of the interposed particles 15 is a value obtained by measuring an intermediate value between a length of a major axis and a length of a minor axis of the interposed particles 15 as the particle diameter from an observation image of the interposed particles 15 magnified and observed with a microscope and averaging 100 or more pieces of measurement data. As the microscope, for example, a scanning electron microscope or an optical microscope is preferably used.

An addition amount of the interposed particles 15 with respect to the metal body 11 is appropriately set according to an abundance ratio of the matrix portion 200 to the first Mg particle portions 400 and the second Mg particle portions 500 of the thixotropically molded product 100A to be produced. A ratio of the addition amount of the interposed particles 15 with respect to the metal body 11 is preferably 0.1 mass % or more and 5.0 mass % or less, and more preferably 0.5 mass % or more and 2.0 mass % or less.

The interposed particles 15 may be mixed particles obtained by mixing two or more types of particles having different constituent materials. In this case, the particle diameter may be different for each type of particles.

The interposed particles 15 may be subjected to any surface treatment as necessary. Examples of the surface treatment include a plasma treatment, a corona treatment, an ozone treatment, an ultraviolet irradiation treatment, a roughening treatment, and a coupling agent treatment.

The bonding portion 13 may contain a substance other than the interposed particles 15. In this case, a content of the substance other than the interposed particles 15 may be less than the content of the interposed particles 15 in terms of mass ratio, and is preferably 10 mass % or less, and more preferably 5 mass % or less of the interposed particles 15.

Examples of the substance other than the interposed particles 15 include the organic binder 16 described above. The organic binder 16 reinforces fixation of the carbon fiber pieces 14 by the interposed particles 15 and enhances a bonding force of the bonding portion 13. In addition, by using the interposed particles 15 and the organic binder 16 in combination, it is possible to obtain the above-described effect while reducing an amount of the organic binder 16 to be used.

### 5.1. Effects of Fourth Embodiment

As described above, the bonding portion 13 preferably contains at least one of the organic binder 16 and the interposed particles 15 containing an inorganic oxide.

Accordingly, the bonding portion 13 bonds the metal body 11 and the carbon fiber pieces 14 more firmly. As a result, the carbon fiber pieces 14 are less likely to fall off from the metal body 11, and finally, the thixotropic molding materials 10 and 10A with which the thixotropically molded products 100 and 100A in which the carbon fiber pieces 14 are uniformly dispersed can be produced are obtained.

In addition, when the interposed particles 15 contain, for example, a silicon oxide, the first Mg particle portions 400 and the second Mg particle portions 500 included in the above-described thixotropically molded product 100A are precipitated. This contributes to further enhancing the rigidity of the thixotropically molded product 100A.

### 6. Method of Producing Thixotropic Molding Material

Next, a method of producing the above-described thixotropic molding materials 10 and 10A will be described.

FIG. 7 is a step diagram showing a method of producing the thixotropic molding materials 10 and 10A.

The method of producing the thixotropic molding materials 10 and 10A shown in FIG. 7 includes a preparation step S102, a stirring step S104, and a drying step S106.

### 6.1. Preparation Step

In the preparation step S102, a mixture containing the metal body 11, the carbon fiber pieces 14, a raw material of the bonding portion 13, and a dispersion medium is prepared. The mixture is a dispersion liquid in which the metal body 11, the carbon fiber pieces 14, and the raw material of the bonding portion 13 are dispersed using a sufficient amount of dispersion medium. The raw material of the bonding portion 13 is at least one of the interposed particles 15 and the organic binder 16.

The dispersion medium is not particularly limited as long as the dispersion medium does not modify the metal body 11, the carbon fiber pieces 14, and the raw material of the bonding portion 13. Examples of the dispersion medium include water, isopropyl alcohol, and acetone. In this step, a mixture produced in advance may be prepared. By containing water in the dispersion medium, it is possible to introduce hydroxy groups in a higher density to the surfaces of the metal body 11, the carbon fiber pieces 14, and the interposed particles 15.

### 6.2. Stirring Step

In the stirring step S104, the mixture is stirred. For stirring, for example, a method of using a stirring rod or a stirring bar, or a method of shaking a container containing a mixture in a state of being covered with a lid is used. By such stirring, the carbon fiber pieces 14 can adhere to the surface of the metal body 11 via the interposed particles 15. A part of the carbon fiber pieces 14 may directly adhere to the surface of the metal body 11 without the interposed particles 15 interposed therebetween. At this stage, the carbon fiber pieces 14 may adhere to the surface of the metal body 11 with a weak adhesive force.

In addition, by stirring, it is possible to prevent the metal bodies 11, the carbon fiber pieces 14, and the interposed particles 15 from aggregating together and forming a lump.

### 6.3. Drying Step

In the drying step S106, the mixture is dried. Accordingly, the carbon fiber pieces 14 adhering to the surface of the metal body 11 via the interposed particles 15 or the organic binder 16 adhere to the metal body 11 more firmly. For example, when hydroxy groups present on the surfaces of the interposed particles 15 and hydroxy groups present on the surfaces of the metal body 11 or the carbon fiber pieces 14 are bonded to each other by a weak adhesive force due to a hydrogen bond or the like, dehydration shrinkage occurs through this step, and the carbon fiber pieces 14 and the metal body 11 are bonded to each other by a stronger adhesive force. For example, silanol groups are present on the surfaces of the interposed particles 15. Through this step, the dehydration shrinkage occurs in the silanol groups, siloxane bonds are generated between the interposed particles 15, and the interposed particles 15 act like an adhesive. In this way, the carbon fiber pieces 14 are fixed to the metal body 11. In addition, the organic binder 16 fixes the carbon fiber pieces 14 to the metal body 11 through melting and solidification by heating in the drying step S106.

For drying, a method of heating the mixture, a method of exposing the mixture to a gas, or the like is used. Among these, in the case of heating the mixture, for example, the entire container containing the mixture may be heated using a hot bath or the like. In the drying step S106, all the dispersion medium in the mixture may be removed, or a part of the dispersion medium may remain without being removed.

As described above, the thixotropic molding materials 10 and 10A are obtained. When the mixture contains the organic binder 16, a degreasing treatment may be performed on the thixotropic molding materials 10 and 10A after the drying step S106.

The thixotropically molded product and the thixotropic molding material according to the present disclosure are described above based on the shown embodiments, and the thixotropically molded product and the thixotropic molding material according to the present disclosure are not limited to the above embodiments, and may be, for example, those obtained by adding any component to the above-described embodiments.

### EXAMPLES

Next, specific Examples of the present disclosure will be described.

### 7. Production of Thixotropically Molded Product

### 7.1. Sample No. 1

First, a magnesium alloy chip as a metal body, pitch-based carbon short fibers as carbon fiber pieces, silicon oxide particles as interposed particles, and IPA (isopropyl alcohol) as a dispersion medium were mixed to obtain a mixture. A chip of 4 mm×2 mm×1 mm made of an AZ91D alloy manufactured by Nippon Material Co., Ltd. was used as the magnesium alloy chip. The AZ91D alloy is an Mg-based alloy containing 9 mass % of Al and 1 mass % of Zn. Colloidal silica obtained by colloidal dispersion in IPA was used as the silicon oxide particles.

Production conditions for other thixotropic molding materials are as shown in Table 1.

Next, the mixture was stirred. A method of shaking a container containing the mixture was used for stirring.

Next, the stirred mixture was heated and dried. Accordingly, a thixotropic molding material was obtained.

Next, the obtained thixotropic molding material was charged into an injection molding machine and subjected to the thixotropic molding to obtain a thixotropically molded product of Sample No. 1. As the injection molding machine, a magnesium injection molding machine JLM75MG manufactured by The JAPAN STEEL WORKS, LTD. was used. Table 2 shows an area fraction of the cross section of the thixotropically molded product.

### 7.2. Sample Nos. 2 to 11

Thixotropically molded products of sample Nos. 2 to 11 were obtained in the same manner as in the case of sample No. 1 except that the production conditions for the thixotropic molding material and the production conditions for the thixotropically molded product were changed as shown in Tables 1 and 2.

### 7.3. Sample No. 12

A thixotropically molded product of sample No. 12 was obtained in the same manner as in the case of sample No. 5 except that a paraffin wax was added as an organic binder in addition to the silicon oxide particles as the interposed particles. An addition ratio of the organic binder to the metal body was set to 0.3 mass %.

### 7.4. Sample No. 13

A thixotropically molded product of sample No. 13 was obtained in the same manner as in the case of sample No. 1 except that the production conditions for the thixotropic molding material and the production conditions for the thixotropically molded product were changed as shown in Tables 1 and 2.

### 7.5. Sample No. 14

A thixotropically molded product of sample No. 14 was obtained in the same manner as in sample No. 5 except that a paraffin wax as an organic binder was added instead of the interposed particles. An addition ratio of the organic binder to the metal body was set to 0.3 mass %.

### 7.6. Sample Nos. 15 and 16

Thixotropically molded products of sample Nos. 15 and 16 were obtained in the same manner as in the case of sample No. 14 except that the production conditions for the thixotropic molding material and the production conditions for the thixotropically molded product were changed as shown in Tables 1 and 2.

### 7.7. Sample Nos. 17 and 18

Thixotropically molded products of sample Nos. 17 and 18 were obtained in the same manner as in sample No. 1 except that a graphite powder shown in Table 1 was used instead of the carbon fiber piece.

### 7.8. Sample Nos. 19 to 21

Thixotropically molded products of sample Nos. 19 to 21 were obtained in the same manner as in the case of sample No. 1 except that the production conditions for the thixotropic molding material and the production conditions for the thixotropically molded product were changed as shown in Tables 1 and 2.

### 7.9. Sample No. 22

The magnesium alloy chip was regarded as a thixotropic molding material of sample No. 22.

TABLE 1

| | | Production condition for thixotropic molding material | | | | | | | | | |
|---|---|---|---|---|---|---|---|---|---|---|---|
| | | Carbon fiber piece | | | | | Interposed particles | | | | |
| | | | Average | Average | Average | | | Average | Particle | | |
| | Example/ | | fiber | fiber | aspect | Addition | | particle | diameter | Addition | Organic |
| Sample | Comparative | Type | diameter | length | ratio | ratio | Type | diameter | ratio | ratio | binder |
| No. | Example | — | μm | μm | — | mass % | — | nm | % | mass % | — |
| 1 | Example | Pitch-based short | 5 | 30 | 6.0 | 5 | Silica | 45 | 0.90 | 0.9 | None |
| | | carbon fiber | | | | | | | | | |
| 2 | Example | Pitch-based short | 7 | 30 | 4.3 | 10 | Silica | 45 | 0.64 | 0.9 | None |
| | | carbon fiber | | | | | | | | | |
| 3 | Example | Pitch-based short | 11 | 30 | 2.7 | 5 | Silica | 45 | 0.41 | 0.9 | None |
| | | carbon fiber | | | | | | | | | |
| 4 | Example | Pitch-based short | 15 | 30 | 2.0 | 10 | Silica | 45 | 0.30 | 0.9 | None |
| | | carbon fiber | | | | | | | | | |
| 5 | Example | Pitch-based short | 11 | 50 | 4.5 | 10 | Silica | 45 | 0.41 | 0.9 | None |
| | | carbon fiber | | | | | | | | | |
| 6 | Example | Pitch-based short | 11 | 80 | 7.3 | 10 | Silica | 45 | 0.41 | 0.9 | None |
| | | carbon fiber | | | | | | | | | |
| 7 | Example | Pitch-based short | 11 | 80 | 7.3 | 15 | Silica | 45 | 0.41 | 0.9 | None |
| | | carbon fiber | | | | | | | | | |
| 8 | Example | Pitch-based short | 11 | 80 | 7.3 | 20 | Silica | 45 | 0.41 | 0.9 | None |
| | | carbon fiber | | | | | | | | | |
| 9 | Example | Pitch-based short | 11 | 100 | 9.1 | 10 | Silica | 45 | 0.41 | 0.9 | None |
| | | carbon fiber | | | | | | | | | |
| 10 | Example | Pitch-based short | 11 | 50 | 4.5 | 15 | Silica | 20 | 0.18 | 0.4 | None |
| | | carbon fiber | | | | | | | | | |
| 11 | Example | Pitch-based short | 11 | 50 | 4.5 | 15 | Silica | 20 | 0.18 | 2.5 | None |
| | | carbon fiber | | | | | | | | | |
| 12 | Example | Pitch-based short | 11 | 50 | 4.5 | 15 | Silica | 20 | 0.18 | 1.8 | Yes |
| | | carbon fiber | | | | | | | | | |
| 13 | Example | PAN-based short | 11 | 50 | 4.5 | 10 | Silica | 45 | 0.41 | 0.9 | None |
| | | carbon fiber | | | | | | | | | |
| 14 | Example | Pitch-based short | 11 | 50 | 4.5 | 10 | — | — | — | — | Yes |
| | | carbon fiber | | | | | | | | | |
| 15 | Example | Pitch-based short | 11 | 50 | 4.5 | 15 | — | — | — | — | Yes |
| | | carbon fiber | | | | | | | | | |
| 16 | Example | Pitch-based short | 11 | 50 | 4.5 | 5 | — | — | — | — | Yes |
| | | carbon fiber | | | | | | | | | |
| 17 | Comparative | Graphite powder | 5 | 5 | 1.0 | 5 | Silica | 45 | 0.90 | 0.9 | None |
| | Example | | | | | | | | | | |
| 18 | Comparative | Graphite powder | 10 | 10 | 1.0 | 10 | Silica | 45 | 0.45 | 0.9 | None |
| | Example | | | | | | | | | | |
| 19 | Comparative | Pitch-based short | 11 | 30 | 2.7 | 0.5 | Silica | 45 | 0.41 | 0.9 | None |
| | Example | carbon fiber | | | | | | | | | |
| 20 | Comparative | Pitch-based short | 11 | 150 | 13.6 | 0.5 | Silica | 45 | 0.41 | 0.9 | None |
| | Example | carbon fiber | | | | | | | | | |
| 21 | Comparative | Pitch-based short | 11 | 30 | 2.7 | 25 | Silica | 45 | 0.41 | 0.9 | None |
| | Example | carbon fiber | | | | | | | | | |
| 22 | Comparative | None | — | — | — | — | — | — | — | — | None |
| | Example | | | | | | | | | | |

In Tables 1 and 2, among the thixotropically molded of product respective sample Nos., those corresponding to the present disclosure are indicated by “Examples”, and those not corresponding to the present disclosure are indicated by “Comparative Examples”.

### 8. Analysis Result of Thixotropically Molded Product

The thixotropically molded product of each sample No. was cut, and a cut surface was observed with an optical microscope. Then, the matrix portion, the carbon fibers, the first Mg particle portions, and the second Mg particle portions were identified from the observation image.

Next, the area fraction S1 of the first Mg particle portions, the area fraction S2 of the second Mg particle portions, and the area fraction S3 of the carbon fibers were calculated. Then, S1+S2, S1/S2, and S3/(S1+S2) were calculated. Calculation results are shown in Table 2. For the sample Nos. 17 and 18, for convenience of description, an average particle diameter and an average aspect ratio of the graphite powder are listed in columns of “average fiber diameter”, “average fiber length”, and “average aspect ratio” in Table 1. Similarly, an area fraction of the graphite powder in the thixotropically molded product is listed in a column of “area fraction S3 of carbon fiber” in Table 2.

### 9. Evaluation Results of Thixotropically Molded Product

### 9.1. Thermal Conductivity

Thermal conductivity of the thixotropically molded product of each sample No. was measured. Then, measurement results were evaluated according to the following evaluation criteria. The evaluation was a relative evaluation with respect to the thermal conductivity of a test piece of sample No. 22.
A: the thermal conductivity is particularly high.
B: the thermal conductivity is high.
C: the thermal conductivity is slightly high.
D: the thermal conductivity is slightly low.
E: the thermal conductivity is low.
F: the thermal conductivity is particularly low.

Evaluation results are shown in Table 2.

### 9.2. Rigidity

A tensile elastic modulus (Young's modulus) of the thixotropically molded product of each sample No. was measured. Then, measurement results were evaluated according to the following evaluation criteria. The evaluation was a relative evaluation with respect to the tensile elastic modulus of the test piece of sample No. 22.
A: the Young's modulus is particularly high.
B: the Young's modulus is high.
C: the Young's modulus is slightly high.
D: the Young's modulus is slightly low.
E: the Young's modulus is low.
F: the Young's modulus is particularly low.

Evaluation results are shown in Table 2.

TABLE 2

| | | Production condition for thixotropically molded product | | | | | | | |
|---|---|---|---|---|---|---|---|---|---|
| | | Area fraction | | | | | | | |
| | | | First | Second | | | | Evaluation result | |
| | | | Mg | Mg | | | | of thixotropically | |
| | | Carbon | particle | particle | | | S3/ | molded product | |
| | Example/ | fiber | portion | portion | S1 + | | (S1 + | Thermal | |
| Sample | Comparative | S3 | S1 | S2 | S2 | S1/S2 | S2) | conductivity | Rigidity |
| No. | Example | % | % | % | % | — | — | — | — |
| 1 | Example | 4.5 | 1.2 | 0.3 | 1.5 | 4.0 | 3.0 | C | C |
| 2 | Example | 19.6 | 1.5 | 1.0 | 2.5 | 1.5 | 7.8 | B | B |
| 3 | Example | 4.4 | 1.0 | 1.5 | 2.5 | 0.7 | 1.8 | C | B |
| 4 | Example | 19.4 | 0.8 | 0.5 | 1.3 | 1.6 | 14.9 | B | B |
| 5 | Example | 19.5 | 1.3 | 0.9 | 2.2 | 1.4 | 8.9 | B | A |
| 6 | Example | 19.5 | 1.2 | 1.0 | 2.2 | 1.2 | 8.9 | A | A |
| 7 | Example | 24.1 | 1.0 | 0.8 | 1.8 | 1.3 | 13.4 | A | A |
| 8 | Example | 29.2 | 1.5 | 0.9 | 2.4 | 1.7 | 12.2 | A | A |
| 9 | Example | 16.3 | 1.5 | 0.5 | 2.0 | 3.0 | 8.2 | B | B |
| 10 | Example | 25.2 | 0.4 | 0.3 | 0.7 | 1.3 | 36.0 | A | B |
| 11 | Example | 23.8 | 2.1 | 1.3 | 3.4 | 1.6 | 7.0 | A | A |
| 12 | Example | 22.9 | 1.6 | 1.1 | 2.7 | 1.5 | 8.5 | A | B |
| 13 | Example | 18.9 | 0.9 | 0.5 | 1.4 | 1.8 | 13.5 | A | A |
| 14 | Example | 19.6 | 0.0 | 0.0 | 0.0 | — | — | A | D |
| 15 | Example | 24.0 | 0.0 | 0.0 | 0.0 | — | — | A | B |
| 16 | Example | 4.7 | 0.0 | 0.0 | 0.0 | — | — | A | D |
| 17 | Comparative | 4.4 | 1.0 | 1.5 | 2.5 | 0.7 | 1.8 | D | E |
| | Example | | | | | | | | |
| 18 | Comparative | 19.1 | 1.1 | 1.4 | 2.5 | 0.8 | 7.6 | E | E |
| | Example | | | | | | | | |
| 19 | Comparative | 0.3 | 0.5 | 0.6 | 1.1 | 0.8 | 0.3 | E | E |
| | Example | | | | | | | | |
| 20 | Comparative | 0.3 | 0.5 | 0.6 | 1.1 | 0.8 | 0.3 | A | E |
| | Example | | | | | | | | |
| 21 | Comparative | 33.0 | 0.8 | 1.1 | 1.9 | 0.7 | 17.4 | B | E |
| | Example | | | | | | | | |
| 22 | Comparative | — | 0.0 | 0.0 | 0.0 | — | — | F | F |
| | Example | | | | | | | | |

As shown in Table 2, it is found that the thixotropically molded product obtained in each Example has thermal conductivity and rigidity higher than those of the thixotropically molded product obtained in each Comparative Example. In addition, when the interposed particles are added to the thixotropic molding material, the rigidity is remarkably improved compared to the case in which the interposed particles are not added.

What is claimed is:

1. A thixotropically molded product comprising:
a matrix portion containing Mg as a main component; and
carbon fibers dispersed in the matrix portion, wherein
an area fraction of the carbon fibers in a cross section is 1.08 or more and 30.0% or less.

2. The thixotropically molded product according to claim 1, wherein
an average fiber length of the carbon fibers is 15 μm or more and 150 μm or less.

3. The thixotropically molded product according to claim 1, wherein
an average aspect ratio of the carbon fibers is 1.5 or more and 20.0 or less.

4. A thixotropic molding material comprising:
a metal body containing Mg as a main component;
a carbon fiber piece adhering to a surface of the metal body; and
a bonding portion interposed between the metal body and the carbon fiber piece, wherein
a content of the carbon fiber piece is 1 mass % or more and 20 mass % or less.

5. The thixotropic molding material according to claim 4, wherein
an average fiber length of the carbon fiber piece is 15 μm or more and 150 μm or less.

6. The thixotropic molding material according to claim 4, wherein
the bonding portion contains at least one of an organic binder and interposed particles containing an inorganic oxide.
